(19) United States
(12) Patent Application Publication
(10) Pub. No.: US 2006/0098610 A1
(43) Pub. Date: May 11, 2006

(54) Method for providing a mobile station with seamless coverage in a 2G/3G communication network and a WLAN

(76) Inventors: Krister Sundberg, Sollentuna (SE); Iraj Farhoudi, Taby (SE)

Correspondence Address: ERICSSON INC., 6300 LEGACY DRIVE, M/S EVR C11, PLANO, TX, 75024, US

(21) Appl. No.: 11/100,059

(22) Filed: Apr. 6, 2005

Related U.S. Application Data
(60) Provisional application No. 60/625,184, filed on Nov. 5, 2004.

(51) Int. Cl. H04Q 7/24; H04Q 7/00

(52) U.S. Cl. 370/338; 370/328

(57) ABSTRACT

A method is described herein that enables data traffic to be routed seamlessly to a mobile station which is located in a Second Generation/Third Generation (2G/3G) network and a Wireless Local Area Network (WLAN). In one embodiment of the present invention, the mobile station (MS) receives a signal (e.g., System Information (SI) signal) from a base station system (BSS) which informs the MS that it should check for the presence of one or more WLANs. The MS then scans for beacons that are emitted from one or more WLANs. Once, the MS receives a beacon from a WLAN it can access that WLAN. To access the WLAN, the MS could send a signal to the BSS informing the BSS and possibly a gateway GPRS service node (GGSN) that it has received a beacon from the WLAN. Then, the MS can receive a signal from the BSS (or GGSN) which contains information (e.g., password, encrypted key) that enables the MS to access the WLAN. Once, the MS is attached to the WLAN, then the GGSN or another common node can route data to the MS via the WLAN instead of via the BSS.

### CLAIMING BENEFIT OF PRIOR FILED PROVISIONAL APPLICATION

This application claims the benefit of U.S. Provisional Application Ser. No. 60/625,184 filed on Nov. 5, 2004 and entitled “New Parameter for Reporting WLAN Service” which is incorporated by reference herein.

### BACKGROUND OF THE INVENTION

1. Field of the Invention

The present invention relates in general to the wireless telecommunications field and, in particular, to a method for routing data traffic, seamlessly, to a mobile station that is located in a Second Generation/Third Generation (2G/3G) network and a Wireless Local Area Network (WLAN).

2. Description of Related Art

In the telecommunications business, there has been an increased interest in how to make different radio technologies, e.g. 2G/3G communication network and WLAN, seamlessly interact with one another. To seamlessly interact a 2G/3G communication network and WLAN, the 2G/3G operator needs to be able to offer a mobile station (e.g., cellular handset, portable computer) the opportunity to access a WLAN hotspot when the MS is located in the coverage area of the WLAN. And, once the MS accesses the WLAN, then the 2G/3G operator should send some or all data (flows) through the WLAN to the MS. This is desirable because the WLAN typically can provide a relatively high bandwidth within its limited coverage to the MS with a relatively low cost to the MS and the 2G/3G operator. However, today there is no integrated way for a base station subsystem (BSS) to inform a MS that there is a WLAN hotspot in the area, or for the MS to inform the BSS that it has detected a WLAN hotspot. Instead, the current method used today is one where, the MS once it's WLAN part is on always “sniffs” for WLAN coverage, although most of the time there is no coverage. The MS's “sniffing” in an attempt to find and access a WLAN is not efficient and has an adverse impact on the MS's battery. Accordingly, there is a need for an integrated way for a BSS to inform a MS that there is a WLAN in the area, and for the MS to inform the BSS that it has detected the WLAN. These needs and other needs are addressed by the present invention.

### BRIEF DESCRIPTION OF THE INVENTION

The present invention includes a MS that receives a signal (e.g., System Information (SI) signal) from a BSS which informs the MS that it should check for the presence of one or more WLANs. The MS then turns on WLAN RF and scans for beacons that are emitted from one or more WLANs. Once, the MS receives a beacon from a WLAN it can access that WLAN. To access the WLAN, the MS could send a signal to the BSS informing the BSS and possibly a gateway GPRS service node (GGSN) that it has received a beacon from the WLAN. Then, the MS can receive a signal from the BSS (or GGSN) which contains information (e.g., password, encrypted key) that enables the MS to access the WLAN. Once, the MS is attached to the WLAN, then the GGSN or another common node can route data to the MS via the WLAN instead of via the BSS.

### BRIEF DESCRIPTION OF THE DRAWINGS

A more complete understanding of the present invention may be had by reference to the following detailed description when taken in conjunction with the accompanying drawings wherein:

FIG. 1 is a flowchart that illustrates the basic steps of a preferred method for providing seamless coverage to a MS located in a 2G/3G communication network and a WLAN in accordance with the present invention;

FIG. 2 is a diagram that illustrates an exemplary 2G/3G communication network that has both operator supported WLANs and non-operator supported WLANs located therein which is used to help describe the method shown in FIG. 1;

FIG. 3 is a signal flow diagram that illustrates how the present invention can be used in a scenario where data which was being sent between the MS and BSS can be handed-off (re-routed) so it can be sent between the MS and WLAN after the MS accessed the WLAN;

FIG. 4 is a signal flow diagram that illustrates how the present invention can be used in a scenario where data which was being sent between the MS and WLAN can be handed-off (re-routed) so it can be sent between the MS and BSS after the MS losses the WLAN coverage; and

FIG. 5 is a signal flow diagram that illustrates how the present invention can be used in another scenario where data which was being sent between the MS and WLAN can be handed-off (re-routed) so it can be sent between the MS and BSS after the MS losses the WLAN coverage.

### DETAILED DESCRIPTION OF THE DRAWINGS

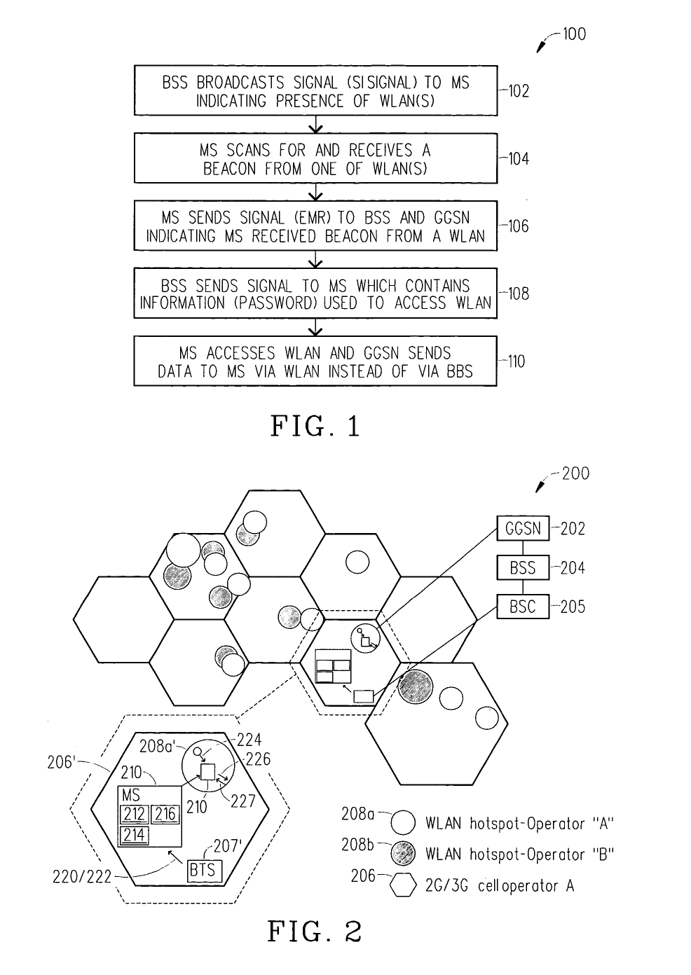

Referring to FIG. 1, there is a flowchart that illustrates the steps of a preferred method 100 for providing a MS with seamless coverage when it is located within a 2G/3G communication network and a WLAN. To aid in the discussion of method 100, an exemplary 2G/3G communication network 200 is used which is shown in FIG. 2. The 2G/3G communication network 200 includes a GGSN/SGSN 202 and a BSS 204 (only one shown). The BSS 204 controls one or more base station controllers (BSCs) 205 (only one shown) which in turn controls one or more base transceiver stations (BTSs) 207 (only one shown). In addition, the 2G/3G communication network 200 has a series of cells 206 anyone of which can have operator supported WLAN(s) 208a and/or non-operator supported WLAN(s) 208b located therein. Each cell 206 also has a BTS 207 located therein. A MS 210 is also shown which includes a receiver 212, a transmitter 214 and a processor 216. It should be understood that many details and components associated with the 2G/3G communication network 200 and MS 210 are well known in the industry. Therefore, for clarity, the description provided herein omits those well known details and components associated with the 2G/3G communication network 200 and MS 210 that are not necessary to understand the present invention.

Beginning at step 102, the BSS 202 and in particular one of the BTSs 207 located in one of the cells 206 broadcasts a signal 220 that can be received by the MS 210. Upon receiving the signal 220, the MS 210 is informed about the presence of one or more WLANs 208a and 208b. These WLANs 208a and 208b are located within the cell 206 that is currently occupied by the MS 210. In this example, the MS 210 is located in cell 206′ and is informed about the presence of one operator supported WLAN 208a′.

In the preferred embodiment, the signal 220 is a system information (SI) signal 220 which includes one or more service set identifiers (SSIDs) 222. Each SSID 222 can be a 32-character unique identifier that differentiates one WLAN 208a from another WLAN 208b. In this example, the MS 210 obtains one SSID 222 which is associated with WLAN 208a′. In an alternative embodiment, the signal 220 can include an index or some other identifying means which enables MS 210 to identify by itself a plurality of pre-defined and pre-stored SSIDs. In this case, the SI signal would not have to include the SSIDs 222. In yet another embodiment, the signal 220 can include one or more MAC addresses which are used by the MS 210 to identify the nearby WLANs 208a and 208b. In still yet another embodiment, the signal 220 can include a frequency band, encryption information or a specific technology which enables the MS 210 to scan for and receive one of the beacons that are emitted from one of the WLANs 208a and 208b (see step 104). Lastly, the signal 220 may simply indicate the presence of one or more nearby WLANs 208a and 208b.

At step 104, the MS 210 scans for and receives a beacon 224 (WLAN broadcast channel) that is broadcasted by WLAN 208a′. In accordance with the present invention, the MS 210 would use the information (e.g., SSID, pre-defined SSID, MAC, frequency band, technology) in signal 220 to help scan for and receive the beacon 224 broadcasted by WLAN 208a′. It should be appreciated that the MS 210 would not scan for the broadcasted beacon 224 until after it was informed about the presence of the WLAN 208a′ (see FIG. 2). And, the MS 210 would receive the broadcasted beacon 224 when it was located in the coverage area of the WLAN 208a′. A benefit of steps 102 and 104 is that the MS 210 no longer has to continuously “sniff” to find WLAN coverage. As a result, steps 102 and 104 reduce the power consumed by the MS's battery as well as enhance the network integrity.

At step 106, the MS 210 sends a signal 226 to the BSS 204 via the BTS 207′ which indicates that the MS 210 received the beacon 224 broadcasted by WLAN 208a′. The BSS 204 can in turn inform the GGSN 202 or other common node. In the preferred embodiment, the uplink (UL) signal 226 can be an enhanced measurement report (EMR) signal 226. The EMR signal 226 in addition to reporting that the MS 210 had located the WLAN 208a′ can also report other information associated with the WLAN 208a′ like signal strength, quality, admission duration, time stamp, synchronization info and statistical visit occurrences etc. . . . Alternatively, the UL signal 226 can be sent as a Call Control Message on a Fast Associated Control Channel (FACCH) signal (see 3GPP 24.008 v 5.7.0). In yet another embodiment, the UL signal 226 can be a signal 226 that is sent over a physical channel (PS) when the MS 210 is in an idle mode or in a PS session. In still yet another embodiment, the MS 210 can send the signal 226 directly to the GGSN 202 via the WLAN 208a′.

At step 108, the BSS 202 and in particular one of the BTSs 207 in response to receiving UL signal 226 sends a DL signal 227 to the MS 210. The MS 210 uses the information in the DL signal 227 to access the one WLAN (see step 110). In the preferred embodiment, the DL signal 227 contains information (possibly encrypted information) that includes a password, a WEP key or a WPA key. Alternatively, it should be appreciated that the MS 210 could simply access the WLAN after completion of step 104.

At step 110, the MS 210 accesses the WLAN 208a′ In the preferred embodiment, the MS 210 can use the information (e.g., password, WEP key, WPA key) in the DL signal 227 to access the WLAN 208a′. In this way, the integrity of WLAN 208a′ is enhanced since a device (e.g., another MS) is not permitted to access the WLAN 208a′ unless it can provide the password, WEP key or WPA key (for example). In the event, the MS 210 scans for and receives more than one beacon 224 during step 104 then it would access the WLAN 208a and 208b that had the strongest beacon 224. Or, the MS 210 can select which WLAN 208a and 208b to access based on some pre-defined strategy, e.g. WLAN assessed before WiMax. After all of this, the GGSN 202 can now send data to MS 210 via WLAN 208a′ instead of via BSS 204.

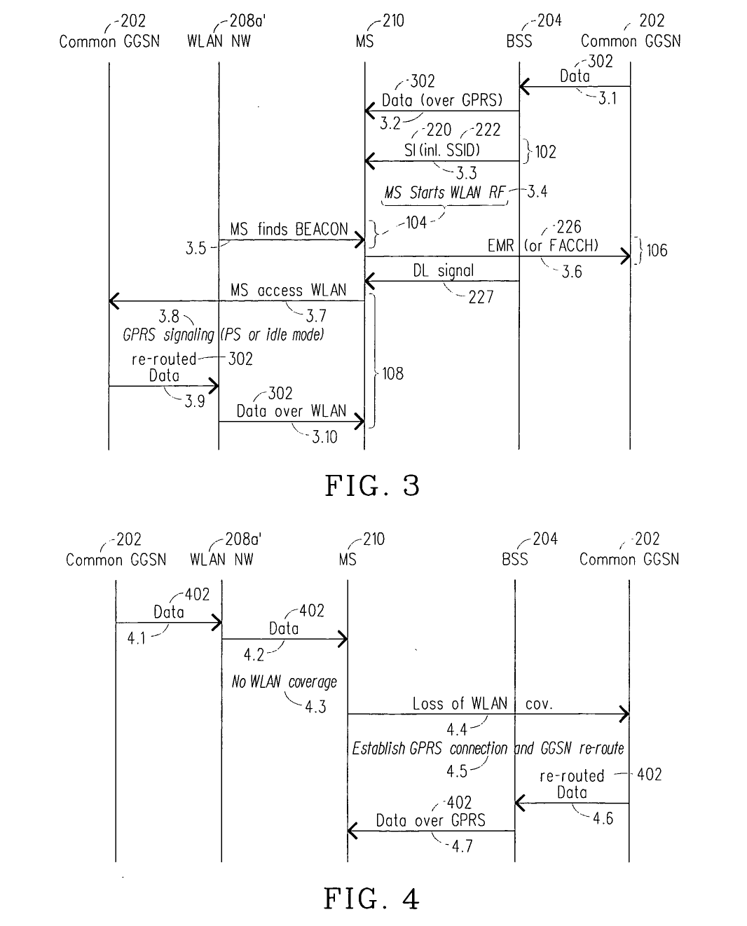

As described above, once the MS 210 is informed by the BSS 204 as to when to perform WLAN measurements (when a WLAN coverage is likely) and after the MS 210 reports the finding of a WLAN 208a′, the 2G/3G operator can provide a seamless service to the MS 210 using the available WLAN 208a′ as a complement to the 2G/3G communications network 200. In particular, the present invention enables the GGSN 202 to send some or all data flows (e.g., WAP or push-to-talk flows not sent) to the MS 210 via WLAN 208a′ after the MS 210 has accessed WLAN 208a′. Otherwise, the GGSN 202 sends data to the MS 210 via the BSS 204 when the MS 210 does not have access to WLAN 208a′. A more detailed discussion about several exemplary ways the present invention can be used to hand-off (re-route) data between the BSS 204 and the WLAN 208a′ is provided below with respect to FIGS. 3-5.

Referring to FIG. 3, there is a signal flow diagram that illustrates how the present invention can be used in a scenario where data which was being sent between the MS 210 and BSS 204 can be handed-off (re-routed) so it can be sent between the MS 210 and WLAN 208a′ after the MS 210 has accessed WLAN 208a′. In this scenario, the GGSN 202 is sending data 302 to the MS 210 via the BSS 204 (see steps 3.1 and 3.2). The BSS 204 (in particular BTS 207′) also transmits a SI signal 220 which includes a list of SSIDs 222 (see step 3.3 and step 102). Upon receiving the SI signal 220, the MS 210 is informed about the presence of one or more WLANs 208a and 208b. In this scenario, only one WLAN 208a′ is shown. The MS 210 then scans for and receives the beacon 224 that is broadcasted by WLAN 208a′ (see steps 3.4 and 3.5 and step 104). As described above, the MS 210 receives a beacon 224 when it is located in the coverage area of WLAN 208a′ which has a known SSID. Thereafter, the MS 210 sends a signal 226 to the GGSN 202 via the BSS 204 (see step 3.6 and step 106). Then, the BSS 204 (or GGSN 202) can send a DL signal 227 to the MS 210. This time even more detailed, the DL signal 227 contains information like a password, a WEP key or a WPA that the MS 210 needs to use to access the WLAN 208a′. Thereafter, the MS 210 accesses the WLAN 208a′ (see step 3.7 and step 108). At this point, the GGSN 202 establishes GPRS signaling (step 3.8) and then re-routes some or all of the data 302 so it is now sent to the MS 210 via the WLAN 208a′ instead of via the BSS 204 (see steps 3.9 and 3.10 and step 108). Before the GGSN 202 re-routes the data 302, the MS 210 may have to send request (e.g., HTTP request) to the GGSN 202.

Referring to FIG. 4, there is a signal flow diagram that illustrates how the present invention can be used in a scenario where data which was being sent between the MS 210 and WLAN 208a′ can be handed-off (re-routed) so it can be sent between the MS 210 and BSS 204 after the MS 210 losses the WLAN coverage. In this scenario, the GGSN 202 is sending data 402 to the MS 210 via the WLAN 208a′ (see steps 4.1 and 4.2). The MS 210 moves out off the coverage area of WLAN 208a′ (see step 4.3). Then, the MS 210 informs the GGSN 202 via the BSS 204 about the loss of the WLAN coverage (see step 4.4) e.g. using GPRS signaling. Next, the GGSN 202 and BSS 204 establish a data flow using for example a General Packet Radio Service (GPRS) connection with the MS 210 (see step 4.5). And, then the GGSN 202 re-routes the data 402 to the MS 210 via the BSS 204 (see steps 4.6 and 4.7).

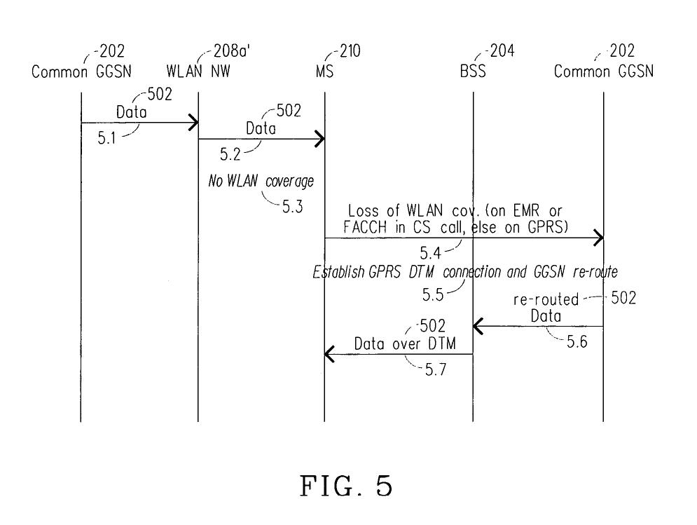

Referring to FIG. 5, there is a signal flow diagram that illustrates how the present invention can be used in another scenario where data which was being sent between the MS 210 and WLAN 208a′ can be handed-off (re-routed) so it can be sent between the MS 210 and BSS 204 after the MS 210 losses the WLAN coverage (during CS call→second signal over EMR or FACCH). In this scenario, the GGSN 202 is sending data 502 to the MS 210 via the WLAN 208a′ (see steps 5.1 and 5.2). The MS 210 moves out of the coverage area of WLAN 208a′ (see step 5.3). Then, the MS 210 informs the GGSN 202 via the BSS 204 about the loss of the WLAN coverage (see step 5.4). Next, the GGSN 202 and BSS 204 establish a connection (e.g., GPRS DTM connection) with the MS 210 (see step 5.5). And, then the GGSN 202 re-routes the data 502 to the MS 210 via the BSS 204 (see steps 5.6 and 5.7).

From the foregoing, it can be readily appreciated by those skilled in the art that the present invention described herein includes a MS 210 which can seamlessly receive data from either, or both, a BSS 204 or a WLAN 208a and 208b depending on its' location within a cell 206. To enable this, the MS 210 includes a receiver 212 that receives a signal 220 (e.g., SI signal 220 with SSIDs 222) which indicates one or more WLANs 208a and 208b are located within a certain coverage area 206 of a 2G/3G communications network 200. Then, the receiver 212 scans for and receives one or more beacons 224 that are emitted from the one or more WLANs 208a and 208b. The MS 210 also includes a transmitter 214 that sends a signal 226 (e.g., EMR 226) to the BSS 204 confirming the receipt of a beacon 224 from WLAN 208a′ (for example). The MS 210 further includes a processor 216 that accesses WLAN 208a′. At this point, the MS 210 can receive data from WLAN 208a′ instead of from BSS 204.

Following are some additional features, advantages and uses of the present invention:

The present invention further enables a MS 210 to simultaneously have a voice call in GSM (for example) and download a file in WLAN. And, if the WLAN coverage is dropped, then after the MS 210 informs the GGSN 202 about this change, it will be possible to re-route the traffic from the WLAN 208a′ to the BSS 204 almost instantly.

The MS 210 could request a mapping table of SSIDs so SI signal 220 only needs to include a number indicating which of the SSIDs to use in the specific cell. This is also valid for other information such as type of network or frequency band.

In one embodiment, the SI signal 220 can contain insensitive information such as SSID, frequency band, technology (WIMAX or wlan etc.).

The MS 210 can access the WLAN 208a′ using a USIM (UMTS SIM) or a temporary password. In one example, the temporary password can be sent via SMS (short message service). Alternatively, the temporary password can be sent on GPRS as a response to EMR or as response to a request over GPRS.

The SSID 222 differentiates one WLAN 208a and 208b from another such that all access points and all devices attempting to connect to a specific WLAN 208a′ (for example) must use the same SSID 222. However, a SSID 222 can be sniffed in plain text from a packet. Thus, the SSID 222 does not supply security to the WLAN 208a′. To address this concern, the SSID 222 could frequently be changed. Furthermore additional security can be achieved by providing for example, encryption information such as Wired Equivalent Privacy (WEP) key or a WiFi Protected Access (WPA) key in a response to the found WLAN signal 226.

The present invention can be applied to WiMax networks in addition to WLANs or any other IEEE 802.xx standard compliant network (e.g., WLAN 802.11 and WiMax 802.16). Furthermore, the BSS 204 does not need to be GSM it can be WCDMA or CDMA etc.

The integrity of a WLAN 208a′ (for example) can be increased by frequently changing the network identity (e.g. SSID) where MSs 210 are informed about the current IDs through the 2G/3G communications network 200.

Although the WLAN 208a′ described herein is a network supported by a 2G/3G operator that also supports the 2G/3G communications network 200, it should be appreciated that the 2G/3G operator can also let their MSs 210 access non-operator supported WLANs 208b.

It should be appreciated that the EMR is an optional feature and requires EMR capabilities in the connected MS 210 as well as the BTS 207.

Although one embodiment of the present invention has been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

What is claimed is:

1. A mobile station, comprising:
a receiver for receiving a first signal that indicates one or more WLANs are located within a coverage area of a cell in a 2G/3G communications network;
said receiver for scanning for one or more beacons that are emitted from the one or more WLANs;
said receiver for receiving one of the beacons that are emitted from one of the WLANs; and
a processor for accessing the one WLAN.

2. The mobile station of claim 1, wherein said first signal is a SI signal which includes one or more SSIDs.

3. The mobile station of claim 2, wherein said receiver uses the one or more SSIDs to scan for and receive one of the beacons that are emitted from one of the WLANs.

4. The mobile station of claim 3, wherein said SI signal further includes a frequency band or encryption information which enables said receiver to scan for and receive one of the beacons that are emitted from one of the WLANs.

5. The mobile station of claim 1, further comprising a transmitter that sends a second signal to the 2G/3G communications network which confirms the receipt of the beacon from the one WLAN.

6. The mobile station of claim 5, wherein said second signal is an EMR signal.

7. The mobile terminal of claim 5, wherein said receiver receives a third signal which contains information that enables said processor to access the one WLAN.

8. The mobile station of claim 7, wherein said third signal contains encrypted information that includes at least one of a password, a WEP key or a WPA key.

9. The mobile station of claim 1, wherein said receiver needs to receive said first signal before scanning for the one or more beacons that are emitted from the one or more WLANs.

10. The mobile station of claim 1, wherein said one or more of the WLANs is a WiMAX or an IEEE 802.xx compliant network.

11. A 2G/3G communications network, comprising:
a GGSN;
a BSS; and
a WLAN;
said BSS that broadcasts a first signal which is received by a mobile station, wherein said first signal informs said mobile station about a presence of said WLAN; and
said WLAN that broadcasts a beacon that is scanned for and received by said mobile station.

12. The 2G/3G communications network of claim 11, wherein said BSS receives a second signal from said mobile station, wherein said second signal informs said BSS and said GGSN about said mobile station having received the beacon broadcasted by said WLAN.

13. The 2G/3G communications network of claim 12, wherein said BSS transmits a third signal to said mobile station which contains information that enables said mobile station to access said WLAN.

14. The 2G/3G communications network of claim 13, wherein said GGSN sends data to said mobile station via said WLAN when said mobile station has accessed said WLAN; and
said GGSN sends data to said mobile station via said BSS when said mobile station does not have access to said WLAN.

15. A base station system (BSS), comprising:
a BSC; and
a BTS;
said BTS capable of broadcasting a first signal which informs a mobile station about a WLAN being present within a coverage area of said BTS.

16. The BSS of claim 15, wherein said BTS capable of receiving a second signal which indicates that said mobile station has located said WLAN.

17. The BSS of claim 15, wherein said BTS capable of broadcasting a third signal which contains information used by said mobile station to access the WLAN.

18. The BSS of claim 15, wherein said first signal is a SI signal includes an index which is used by said mobile station to identify a plurality of pre-defined and pre-stored SSIDs.

19. The BSS of claim 15, wherein said second signal is an EMR signal.

20. A method for providing a mobile user with seamless coverage in a 2G/3G communication network and a WLAN, said method comprising the steps of:
broadcasting, from a BSS, a first signal that contains information about one or more WLANs;
receiving, at the mobile station, the first signal which informs the mobile user about the presence of the one or more WLANs;
scanning, at the mobile station, for one or more beacons that are emitted from the one or more WLANs;
receiving, at the mobile station, one of the beacons that are emitted from one of the WLANs;
transmitting, from the mobile station, a second signal to the BSS which informs the BSS about the mobile station having received the one beacon from the one WLAN; and
receiving, at the mobile station, a third signal from the BSS which contains information that enables said mobile station to access the one WLAN.

21. The method of claim 20, further comprising the step of:
sending some or all data flows, from a common node, to the mobile station via the one WLAN when the mobile user has accessed the one WLAN; and
sending data, from the common node, to the mobile station via the BSS when the mobile user does not have access to the one WLAN.
